(19) United States
(12) Patent Application Publication
(10) Pub. No.: US 2026/0225432 A1
(43) Pub. Date: Aug. 6, 2026

(54) SWITCHABLE MIRROR FOR TRANSPARENT VISORS

(71) Applicant: Gentex Corporation, Zeeland, MI (US)

(72) Inventors: Xiaoxu Niu, Grand Rapids, MI (US); Kurtis L. Geerlings, Zeeland, MI (US); David J. Cammenga, Holland, MI (US)

(21) Appl. No.: 19/150,419

(22) PCT Filed: Jan. 8, 2025
(86) PCT No.: PCT/IB2025/050202

§ 371 Date: Jul. 23, 2025

Related U.S. Application Data
(60) Provisional application No. 63/618,540, filed on Jan. 8, 2024.
(60) Provisional application No. 63/681,453, filed on Aug. 9, 2024.

(51) Int. Cl. B60J 3/06; B60J 3/02; B60J 3/04; G02F 1/1335; G02F 1/13363; G02F 1/139

(52) U.S. Cl. CPC B60J 3/06; B60J 3/0213; B60J 3/04; G02F 1/133536; G02F 1/133638; G02F 1/1396; G02F 2201/44

(57) ABSTRACT

An automotive visor includes a selectively-transmissive body. The body element includes an absorptive polarizer layer disposed on a second side of the body element and a liquid crystal cell layer juxtaposed with the absorptive polarizer layer and configurable between an off state and an on state. A reflective polarizer layer is disposed on a first side of the body element and is juxtaposed with the absorptive polarizer layer. The body element is configurable, based on the state of the liquid crystal cell layer, in a transmissive state, wherein light entering the body element in a first polarization state from the first side exits the body on the second side, and a mirror state such that only light incident on the reflective polarizer layer from the second side of the body element is visible from the second side of the body element.

### CROSS-REFERENCE TO RELATED APPLICATION

This application claims priority to and the benefit under 35 U.S.C. § 119(e) of U.S. Provisional Application No. 63/618,540 filed on Jan. 8, 2024, entitled “SWITCHABLE MIRROR FOR TRANSPARENT VISORS,” and U.S. Provisional Application No. 63/681,453 filed on Aug. 9, 2024, entitled “SWITCHABLE MIRROR FOR TRANSPARENT VISORS,” the disclosures of which are hereby incorporated herein by reference in their entirety.

### TECHNOLOGICAL FIELD

The present disclosure relates generally to an automotive visor and more particularly, relates to an automotive visor including a selectively-transmissive body element that transitions between a mirror mode and a transparent mode.

### SUMMARY

According to one aspect of the present invention, an automotive visor includes a selectively-transmissive body element defining a plane extending in first and second directions and having a first side and a second side. The body element includes an absorptive polarizer layer disposed on the second side of the body element, extending along the first and second directions, and configured to transmit light in a first polarization state aligning with the first direction therethrough while absorbing light not in the first polarization state, including light in a second polarization state aligned with a second direction. The body element further includes a twisted nematic liquid crystal cell layer extending along the first and second directions and juxtaposed with the absorptive polarizer layer. The twisted nematic liquid crystal cell layer is configurable between an off state, wherein a polarization state of light transmitted therethrough is reoriented by 90 degrees, and an on state, wherein light is transmitted therethrough without reorientation of the polarization state. A reflective polarizer layer is disposed on the first side of the body element, extends along the first and second directions, is juxtaposed with the absorptive polarizer layer, and is configured to transmit light in the second polarization state, while reflecting light not in the second polarization state, including light in the first polarization state. The body element is configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element. The configuration of the body element corresponds with the state of the twisted nematic liquid crystal cell layer such that the body element is in the transmissive state when the twisted nematic liquid crystal cell layer is in the off state and is in the mirror state when the twisted nematic liquid crystal cell layer is in the on state.

According to another aspect, an automotive visor includes a selectively-transmissive body having an absorptive polarizer layer disposed on a second side of the body element and a liquid crystal cell layer juxtaposed with the absorptive polarizer layer and configurable between an off state and an on state. The body further includes a reflective polarizer layer disposed on a first side of the body element and juxtaposed with the absorptive polarizer layer. The body element is configurable, based on the state of the liquid crystal cell layer, in a transmissive state, wherein only light in a first polarization state enters the body element from the first side and exits the body on the second side, and a mirror state such that only light incident on the reflective polarizer layer from the second side of the body element is visible from the second side of the body element.

According to another aspect, an automotive visor includes a selectively-transmissive body element defining a plane extending in first and second directions and having a first side and a second side. The body element includes an absorptive polarizer layer disposed on the second side of the body element, extending along the first and second directions, and configured to transmit light in a first polarization state aligning with the first direction therethrough while absorbing light not in the first polarization state, including light in a second polarization state aligned with a second direction. The body element further includes a twisted nematic liquid crystal cell layer extending along the first and second directions and juxtaposed with the absorptive polarizer layer, the twisted nematic liquid crystal cell layer being configurable between an off state, wherein a polarization state of light transmitted therethrough is reoriented by 90 degrees, and an on state, wherein light is transmitted therethrough without reorientation of the polarization state. A reflective polarizer layer is disposed on the first side of the body element, extends along the first and second directions, is juxtaposed with the absorptive polarizer layer, and is configured to transmit light in the first polarization state, while reflecting light not in the first polarization state, including light in the second polarization state. The body element is configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element. The configuration of the body element corresponds with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a front perspective view of an automotive visor according to an aspect of the disclosure;

FIG. 2 is a back perspective view of the automotive visor;

FIG. 3 is a perspective view of examples of the automotive visor in place within a vehicle interior;

FIG. 4A is an exploded perspective view of a body element of the automotive visor shown schematically in a transmissive polarization state, the body element being shown in connection with an electrochromic element in a transmissive state;

FIG. 4B is an exploded perspective view of the body element of the automotive visor shown schematically in the transmissive polarization state, the body element being shown in connection with the electrochromic element in a darkened state;

FIG. 5 is an exploded perspective view of a body element and the electrochromic element of the automotive visor shown schematically in a mirror state;

FIG. 6 is a series of plots showing relative transmission of the body element at varying viewing angles;

FIG. 7 is a schematic image of the body element showing the varying viewing angles in association therewith;

FIG. 8 is an exploded perspective view of an alternative body element of the automotive visor shown schematically in an alternative transmissive polarization state;

FIG. 9 is an exploded perspective view of an alternative body element of the automotive visor shown schematically in an alternative transmissive polarization state and including additional components to alter the appearance of the body element when viewed from a first side thereof;

FIG. 10 is an exploded perspective view of an alternative body element for an automotive visor shown schematically in a transmissive polarization state; and

FIG. 11 is an exploded perspective view of the body element of the body element of FIG. 10 shown schematically in a mirror state.

### DETAILED DESCRIPTION OF EMBODIMENTS

The present illustrated embodiments reside primarily in combinations of method steps and apparatus components related to an automotive visor. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

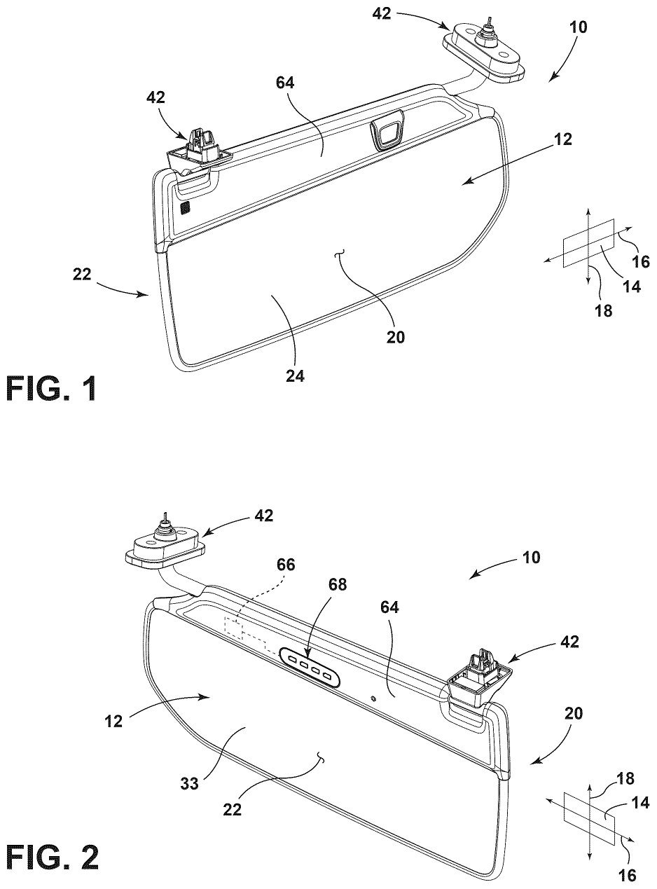

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed automotive visor in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIGS. 1-7, reference numeral 10 generally designates an automotive visor. The automotive visor 10 includes a selectively-transmissive body element 12 defining a plane 14 extending in a first direction 16 and a second direction 18 and having a first side 20 and a second side 22. The body element 12 includes an absorptive polarizer layer 24 disposed on the second side 22 of the body element 12, extending along the first and second directions 16, 18, and configured to transmit light in a first polarization state 26 aligning with the first direction 16 therethrough while absorbing light in a second polarization state 34 that aligns with the second direction 18. The body element 12 also includes a liquid crystal (“LC”) cell layer 30 extending along the first and second directions 16, 18, and juxtaposed with the absorptive polarizer layer 24. In the illustrated example, the LC cell layer 30 is a twisted nematic liquid crystal (“TN-LC”) cell layer 30 that is configurable between an off state, wherein a polarization state of light transmitted therethrough is reoriented by 90 degrees, and an on state, wherein light is transmitted therethrough without reorientation of the polarization state. The body element 12 further includes a reflective polarizer layer 32 facing the first side 20 of the body element 12, extending along the first and second directions 16, 18, juxtaposed with the TN-LC cell layer 30, and configured to transmit light in a second polarization state 34 aligning with the second direction 18 therethrough, while reflecting light in the first polarization state 26. It is to be appreciated that the arrangement described herein can also be implemented in a variation that incorporates a vertical alignment liquid crystal (“VA-LC”) cell layer in place of the aforementioned TN-LC cell layer 30. In such an implementation, discussed further below.

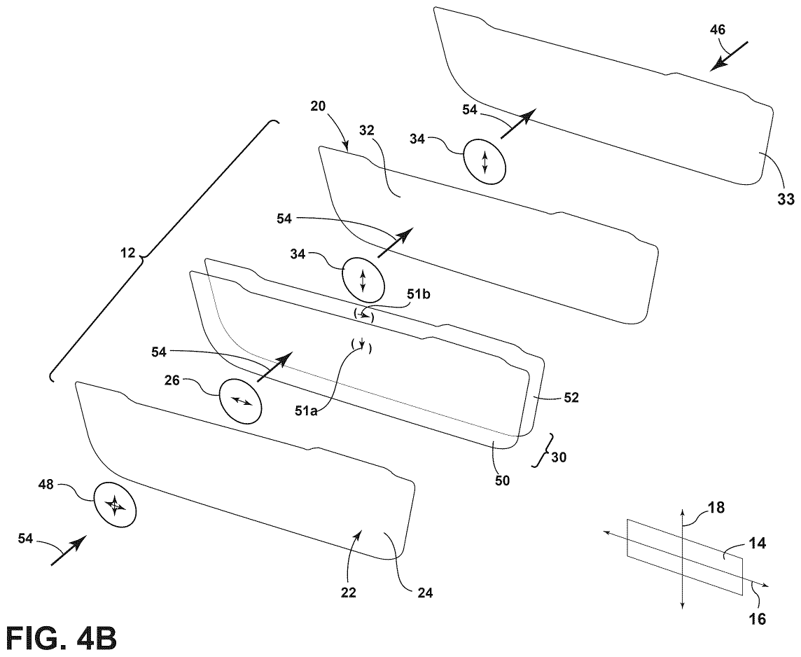

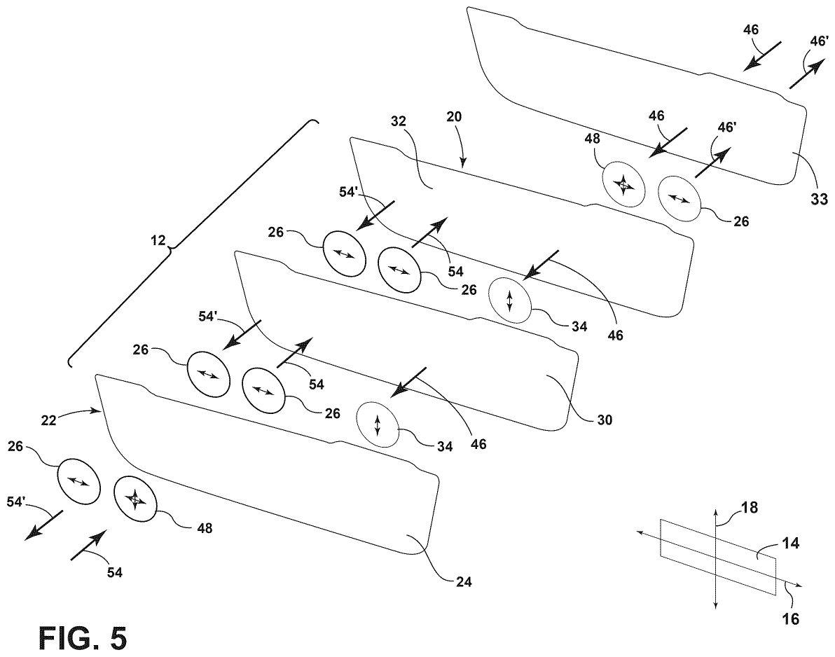

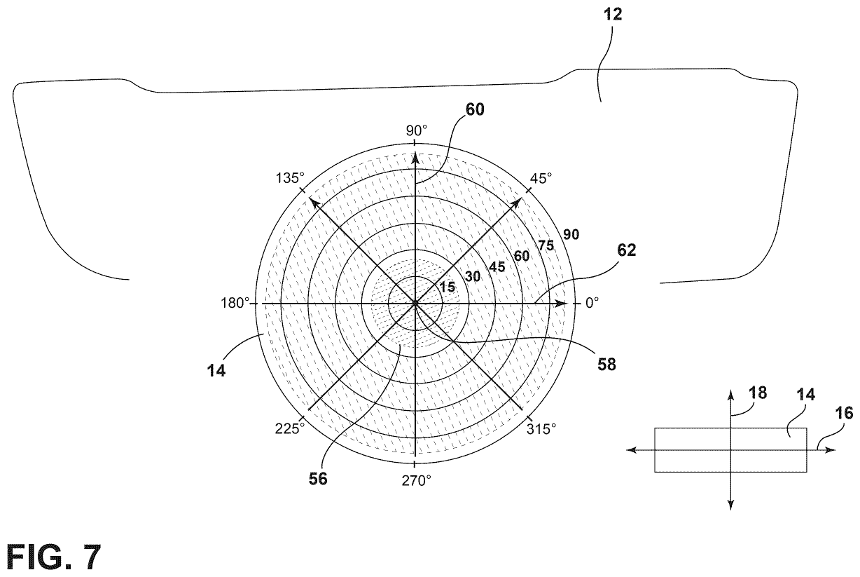

The body element 12 is configurable in a transmissive state (FIG. 4A), wherein light entering the body element 12 from the first side 20 passes through to the second side 22 of the body element 12 in the first polarization state 26, and a mirror state (FIG. 5), wherein light entering the body element 12 from the second side 22 and passing through the absorptive polarizer layer 24 in the first polarization state 26 is reflected back through the absorptive polarizer layer 24 by the reflective polarizer layer 32 in the first polarization state 26, such that only light incident on the reflective polarizer layer 32 from the second side 22 of the body element 12 is visible from the second side 22 of the body element 12, at least within a first viewing angle range 28 (FIG. 7). The configuration of the body element 12 corresponds with the state of the TN-LC cell layer 30 such that the body element 12 is in the transmissive state when the TN-LC cell layer 30 is in the off state and is in the mirror state when the TN-LC cell layer 30 is in the on state.

Additionally, the automotive visor 10 includes an electrochromic element 33 that is generally of the same shape as the body element 12 in the first and second directions 16, 18. As shown in FIGS. 4A and 4B, the electrochromic element 33 is disposed on the first side of the body element 12 adjacent the reflective polarizer 32. The particular structure of the electrochromic element 33 can vary, but it is to be generally appreciated that the electrochromic element 33 is configured so as to exhibit a controllable level of light transmission therethrough. In various examples, the transmission can be from near full transmission (e.g., about 95% or more) to zero light transmission (i.e., fully opaque), depending on the application of an electrical current or potential thereto. In this manner, the incorporation of the electrochromic element 33 allows for the portion of the automotive visor 10 that comprises the electrochromic element 33 to impart a level of selective transmissiveness to the visor 10 such that direct light, for example, can be reduced to a comfortable level without obstructing the view through the portion of the windshield that the electrochromic element 33 overlies (so long as some level of transmission remains within the electrochromic element 33). A further example of an electrochromic element 33 adapted for use in connection with an automotive visor, as well as related structures, is discussed further in commonly-assigned U.S. Provisional Pat. App. No. 63/602,165, the entire disclosure of which is incorporated by reference herein. The incorporation of the electrochromic element allows for an additional state of the automotive visor 10, as shown in FIG. 4B, in which the body element 12 is configured in the transmissive state, details of which are discussed further below, with the electrochromic element 33 configured in the darkened state. Accordingly, the automotive visor 10 is opaque and non-reflective in an arrangement analogous to that of a traditional visor in which the automotive visor 10 can be deployed to shield the user's eyes from the sun or the like. In this respect, the visor 10 can be configured in the mirror state with the electrochromic element 33 in either the darkened state or the transmissive state according to various configurations of controller 66 or the like. In some aspects, the reflectiveness of the body element 12 when in the reflective state may be improved by coordinating configuration of the body element 12 in the reflective state with configuration of the electrochromic element 33 in the darkened state.

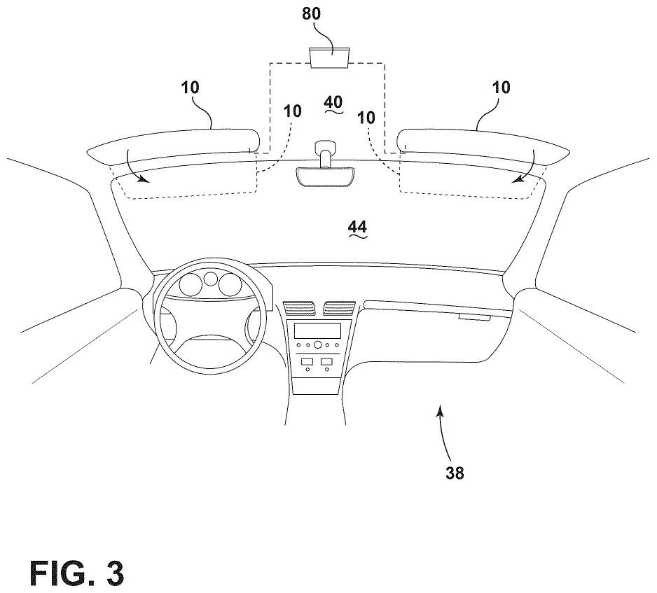

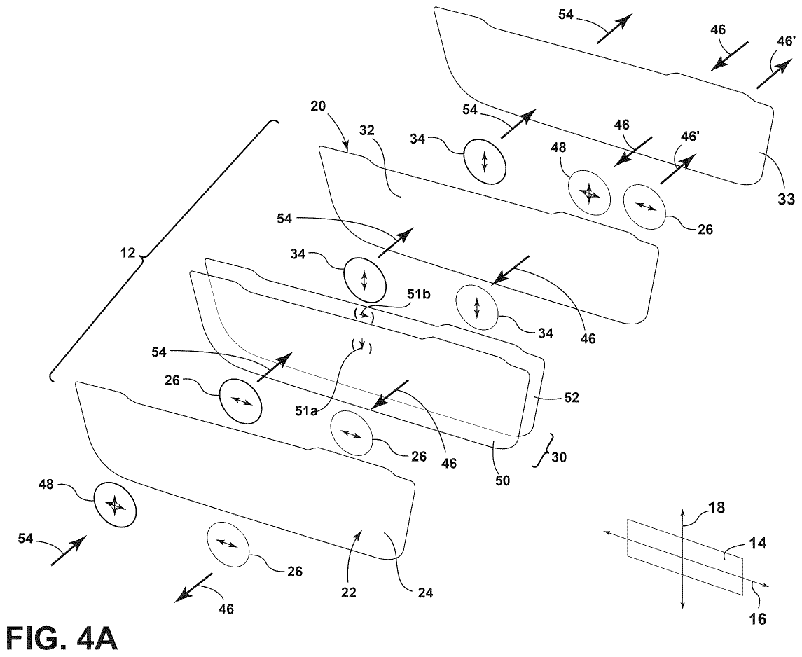

According to an aspect of the present disclosure, the relative orientations of the absorptive polarizer layer 24, the TN-LC layer 30, and the reflective polarizer layer 32 are arranged to suit the body element 12 for use in the described automotive visor 10 application. As can be appreciated, FIG. 3 shows such an automotive visor 10 in place within a vehicle interior 38. In general, automotive visors 10 are mounted to a vehicle headliner 40 by a mounting structure 42 with elements generally disposed on opposite lateral sides of the automotive visor 10 and configured to allow the visor 10 to rotate from a stowed position, wherein the visor 10 is disposed against the headliner 40, and a range of use positions, wherein the visor 10 is rotated downwardly from the headliner 40 to at least partially extend into the user's field of vision with respect to the adjacent vehicle windshield 44 to, for example, shade the user's eyes from direct sunlight visible through the upper portion of the windshield 44, as is typical of standard automotive visors 10. Additionally, in an example, mounting structure 42 can be configured to allow the visor 10 to rotate laterally outward so as to extend along a side window 45 of the vehicle for similar purposes As can be appreciated the automotive visor 10 depicted in FIGS. 1 and 2 is configured for use on a driver side of the vehicle, with a passenger-side visor 10 being generally configured as a mirror image of the depicted automotive visor 10. In this manner, the intrinsic angle dependency characteristics of the above-described body element 12 are configured to realize certain visor-specific features or characteristics. In particular, the relevant parameters for these configurations are liquid crystal orientation, polarizer type, and relative polarizer orientation. As discussed further below, these aspects are configured to exhibit characteristics useful for the automotive application shown generally in FIG. 3 and described above.

In FIG. 4A, the configuration of the present body element 12 in the transmissive polarizer mode is shown, with the electrochromic element 33 in a corresponding transmissive state. In particular, in the transmissive polarizer mode, the body element 12 exhibits relatively high transmittance such that the body element 12 is transparent. In an aspect of the disclosure, the thus-configured visor 10 has beneficial use in the range of deployed positions for a vehicle occupant. In particular, the body 12, when in the depicted transmissive mode, reduces glare for the occupant by polarizing the transmitted light. In particular, as shown schematically in FIG. 4A, light entering the body element 12 from the first side 20 (indicated by arrow 46) is generally understood as comprising randomly-oriented electromagnetic radiation. As shown, the light incident on the first side 20 is the light entering the vehicle from outside through the windshield 44 and is incident first on the reflective polarizer layer 32, which is configured to transmit light vertically-polarized light 34 (which corresponds with the second direction 18, as discussed above), while reflecting horizontally-polarized light 26. In general, blocking the transmission of horizontally-polarized light reduces the appearance of glare and provides a better viewing experience to the user with less eye strain, which can provide benefits generally expected of an automotive visor 10 without obstructing the occupant's view. The light 46′ (i.e., light that is in the first polarization state 26) is reflected back toward the windshield 44.

As further shown in FIG. 4A, the polarized light 46 that is transmitted through the reflective polarizer layer 32 then passes through the TN-LC layer 30. As discussed above, when in the “off” state (which can correspond with a state of the layer 30 when not powered) the TN-LC layer 30 rotates the polarization angle of the light passing therethrough. In the present example, the TN-LC layer 30 is configured to rotate the transmitted light by 90 degrees. Even more specifically, in the example of FIG. 4A, the light is rotated by 90 degrees (with reference to a direction facing the first side 20 of the body element 12). Accordingly, when the TN-LC layer 30 is in the off state, the light exits the TN-LC layer 30 in the first polarization state 26, which corresponds with the horizontal first direction 16 in the present example, but may vary depending on certain implementations. In this respect, the absorptive polarizing layer 24 is configured such that light 46 in the first polarization state 26 is transmitted therethrough such that the light 46 entering through the first side 20 is ultimately transmitted through the absorptive polarizing layer 24 and out through the corresponding second side 22 of the body element 12 so as to be viewable to the occupant, while being beneficially polarized.

As can be appreciated, the TN-LC cell layer 30 as used in the present automotive visor 10 includes two separate alignment layers 50 and 52. The alignment layers 50, 52, are positioned on opposite sides of a liquid crystal medium according to various known configurations for realizing a twisted nematic structure capable of rotating the polarization angle, as discussed above. It is to be appreciated that the liquid crystal medium (not shown) is positioned between the two alignment layers 50 and 52, with the TN-LC cell layer 30 further including substrates on both sides of the alignment layer, with the substrates incorporating the electrode layers (not shown) used to power the TN-LC cell layer 30, as discussed further below, by generating an electric field between the two electrode layers. Each alignment layer 50, 52, is characterized in part by a “rubbing direction” that influences the orientation and alignment of the crystals within the liquid crystal medium adjacent to each respective alignment layer 50, 52, when the TN-LC cell layer is in the unpowered condition indicated in FIG. 4A. Rubbing direction can mean any method that aligns the liquid crystal material in a specific direction on the alignment layer 50, 52. It is the rubbing directions 51a, 51b that determines the alignment of the liquid crystal material with respect to the surface of the adjacent alignment layer 50 or 52. As shown in the schematic of FIG. 4A, alignment layer 50 is characterized by a rubbing direction oriented in the second direction 18 and moving from left-to-right relative to the view shown in FIG. 4A, and the alignment layer 52 is characterized by a rubbing direction oriented in the first direction 16 and moving from bottom-to-top relative to the view shown in FIG. 4A. This specific configuration results in rotation of the light 46 that enters the TN-LC cell layer 30 from the reflective polarizer layer 32.

It is additionally noted that light 54 that is incident on the second side 22 of the body element 12 (i.e., from inside the vehicle) first encounters the absorptive polarization layer 24 such that light 54 in the first polarization state 26 (i.e., oriented along the second direction 18) is transmitted therethrough, with light in the second polarization state 34 being absorbed. As further shown in FIG. 4A, the light 54 that passes through the absorptive polarizer layer 32 is twisted by the TN-LC cell layer 30 into the second polarization state 34 such that it is then transmitted through the reflective polarizer layer 32. The light 54 then exits the first side 20 of the body element 12 and passes to the ambient environment. It is noted that, when discussing the absorption and reflection of light, as well as the polarization thereof, there are certain levels of inefficiency that lead to some light not corresponding with the desired state moving through the polarizer, which corresponds with some level of light not being reflected or absorbed. Accordingly, the description herein is generalized with respect to the directions and is intended to encompass or account for such inefficiencies.

Turning to FIG. 5, when the TN-LC layer 30 is changed to the “on” state (such as by providing an electrical field to the electrode layers), the TN-LC cell layer 30 does not cause any appreciable twisting of light passing therethrough in either direction. Accordingly, a portion of light 54 passes through the absorptive polarization layer 24 from the second side 22 (i.e., from within the vehicle interior 38) in the first polarization state remains in the first polarization state 26 when passing through the TN-LC cell layer 30 such that the light 54′ is reflected back toward the second side 22 by the reflective polarization layer 32, passing back through the TN-LC cell layer 30 and back through the absorptive polarizer layer 24, still in the first polarization state 26. In this manner, none of the light 46 entering the first side 20 of the body element 12 is transmitted through to the second side 22 such that the transmissiveness of the body element 12 is reduced. This occurs because light in the first polarization state 26 is reflected back 46′ by the reflective polarization layer 32 (i.e., back toward the windshield 44), while the light in the second polarization state 34 that passes through the reflective polarization layer 32 remains in the second polarization state 34 when passing through the TN-LC cell layer 30, such that the light 46 is absorbed by the absorptive polarization layer 24. The lack of transmission of light 46 from the first side 20 through the body element 12 is such that there is no image competition from light transmitted from the first side 20 to the second side 22, which improves the visibility of any image in the light 54′ reflected from the second side 22 by the reflective polarization layer 32 (and back through the second side 22). In the configuration of FIG. 5, the body element 12 is, accordingly, useable as a mirror from the second 22 side (which faces the vehicle interior when in the deployed positions).

As further shown in FIG. 3, an additional controller 80 within the vehicle can be configured to coordinate lighting within the interior 38 of the vehicle with the configuration of the automotive visor, including by illuminating at least some of the lighting in connection with the automotive visor 10 being deployed and in the mirrored state of FIG. 5.

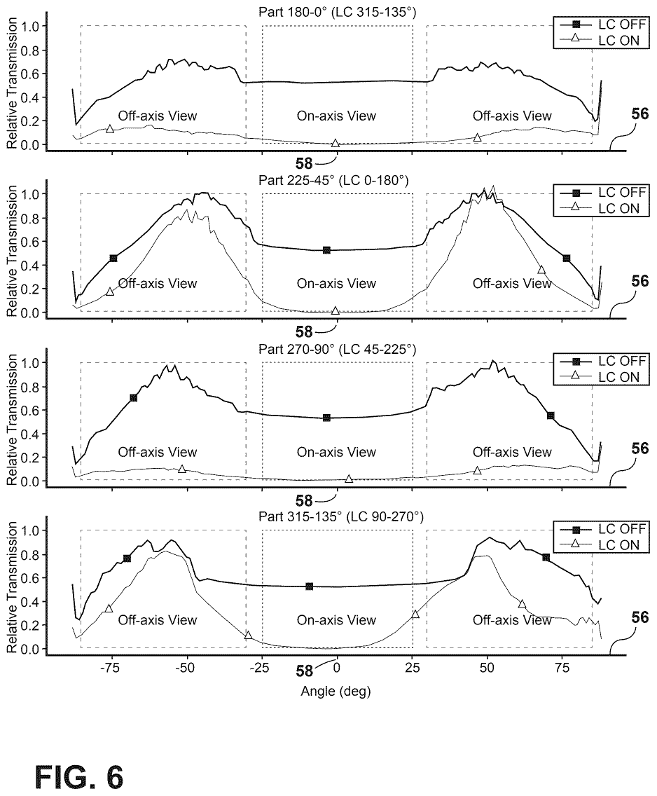

Again, because polarizers and TN cells in general are optimized for viewing normal to the surface, so-called “off angle” viewing may exhibit certain characteristics that, in certain settings, would be considered non-optimal. Notably, the amount of light reflected back may vary with the alignment relative to the second (transmitted) polarization state 34. Similarly, the amount of light absorbed by the absorptive polarization layer 24 may vary with the closeness to the first polarization state 26. As shown in the graphs of FIG. 6, the transmission and reflection through the body element 12 observed through the second side 22 are shown in terms of the “relative transmission”, which presents transmission readings normalized to the highest reading, which is given a value of 1.0, shown on the Y-axes that varies not only according to an angle, measured on the X-axis, from normal 58, corresponding to the measurement angle relative to the angle normal to the plane 14 of the viewing angle 56, as shown in the various plots and indicated in the polar plot of FIG. 7. As mentioned above, this variation in relative transmission can be configured for particular usefulness in the present implementation of the automotive visor 10. As generally shown, the relative transmission of the body element 12 is near zero (resulting in the above-described mirror appearance) when the TN-LC cell layer 30 is in the on state and the viewing angle 56 is within the above mentioned first viewing angle range 28 of about 25° from normal 58 for all positions along plane 14. When the viewing angle 56 is greater than about 25° from normal 58, the relative transmission can vary with the polar orientation of the viewing angle 56 relative to the plane 14. In particular, when viewed along the vertical axis 60 and the horizontal axis 62, the relative transmission remains low, even outside the 25° viewing angle 56 such that, when the TN-LC cell layer 30 is on, the second side 22 will retain the mirror appearance. This can be useful in that the automotive visor 10 can be in various use conditions that are not vertically angled directly at the user for use as a mirror. Similarly, the user, when vertically positioned normal to the second side 22, can move laterally, while still using the automotive visor 10 as a mirror.

When the viewing angle 56 is oriented between these positions (i.e., on an axis extending from the 225° position to about the 45° position and from about the 315° position to about the 135° position, according to the polar coordinates shown in FIG. 7), however, the relative transmission is higher such that the second side 22 will exhibit a transparent appearance, even when the TN-LC cell layer 30 is on. This characteristic can be useful in that the driver, for example, may still be able to see through the passenger-side visor 10 when being used by the adjacent passenger as a mirror. In the present example, it is noted that these characteristics are generally achieved by aligning the directions 51a and 51b of the alignment layers 50 and 52 with the with the transmission angles of the absorptive polarizer layer 24 and the reflective polarizer layer 32 (i.e., with the respective directions all corresponding with one of the first 16 or second directions 18).

In the present example, where the reflective polarizer 32 has a vertical transmission angle (i.e., in second direction 18 corresponding with the second polarization state 34) and the absorptive polarizer layer 32 has a horizontal transmission angle (i.e., in the first direction 16 corresponding with the first polarization state 26). In this configuration an observer wearing polarized sunglasses would not be able to see through the visor 10 regardless of the activation of the TN-LC cell layer 30, as the light passing through the absorptive polarizer layer 24 will be horizontally polarized (first polarization state 26), which is the polarization blocked by polarized sunglasses. For this arrangement, it may be desired to modify the light that is passing through the absorptive polarizer layer 24 toward the observer. In one aspect, this could be done by changing the linear polarization to circular polarization by inserting a quarter wave retarder material between the absorptive polarizer layer 24 and the observer. Alternatively, the linearly polarized light from the absorptive polarizer layer 24 could be reconfigured so as to be at least partially out of its current state by using one of a number of methods or materials suited for such a purpose. Such materials may change the light incident thereon to an elliptical, or more specifically, a circular polarization state. Again, this material would need to be inserted between the absorptive polarizer layer 24 and the observer. A still further arrangement to improve compatibility with polarized sunglass issue is to add a half-wave retarder layer on the second side of the body element 12 again between the absorptive polarizer layer 24 and the observer. The half-wave retarder rotates linearly-polarized light by 90° in a manner similar to the above-described TN-LC cell layer 30, without the ability to change states (a quarter-wave retarder rotating linearly-polarized light by 45°). In the present example this arrangement would rotate the horizontally polarized light to vertically polarized light which will be visible through polarized sunglasses. In another example, the polarization directions of the absorptive polarization layer 24 and the reflective polarization layer 32 can be rotated by 90°.

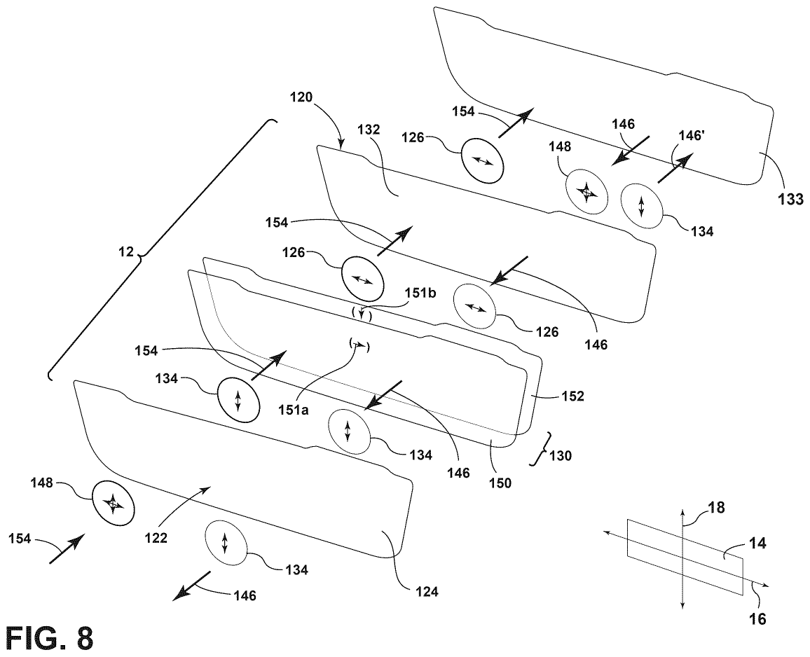

Turning to FIG. 8, an alternative arrangement for body element 112 is shown, in which the polarization directions of the reflective polarization layer 132 and the absorptive polarization layer 124 are rotated by 90°, as compared to the reflective polarization layer 32 and the absorptive polarization layer 24 of FIGS. 4A-5. Additionally, the rubbing directions 151a and 151b of the alignment layers 150 and 152 are in different directions, resulting in counter-clockwise twisting by 90° of the light passing therethrough. In particular, as shown in the schematic of FIG. 8, alignment layer 150 is characterized by a rubbing direction 151a oriented in the first direction 16 and moving from left-to-right relative to the view shown in FIG. 8 (which is similar to that of the alignment layer 50 in FIG. 4A), and the alignment layer 152 is characterized by a rubbing direction 151b oriented in the second direction 18 and moving from top-to-bottom relative to the view shown in FIG. 8 (i.e., opposite that of alignment layer 52 in FIG. 4). This specific configuration results in a twisting of the light 146 that enters the TN-LC cell layer 130 from the absorptive polarizer layer 124 in the counterclockwise direction by 90°, as discussed above. In this respect, it is noted that other features not specifically discussed herein are similar to those discussed above, with such features being indicated in FIG. 8 with similar reference numbers increased by 100.

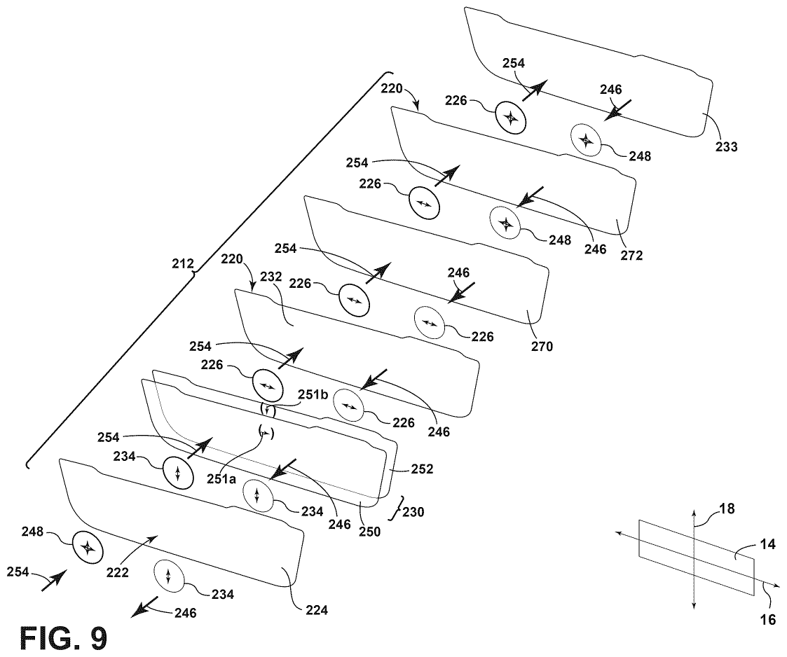

As shown in FIG. 9, in a further aspect of the disclosure, an automotive visor 210 that is a variation of the automotive visor 10 shown in FIG. 4A includes additional layers on the first side 220 of the body element 212. In this respect, it is noted that other features not specifically discussed herein are similar to those discussed above, with such features being indicated in FIG. 9 with similar reference numbers increased by 200. In particular, the body element 212 includes a second absorptive polarizer 270 outside of the reflective polarizer 232 (which is generally similar to the reflective polarizer 32 discussed above). As shown, the second absorptive polarizer 270 is configured to transmit light oriented in the above-described first state 226, while absorbing light oriented in the second state 234 (or at least outside of the first state 226). By way of this arrangement, the light incident on the first side 220 of body element 212, when the electrochromic element 233 is in the transmissive state, is either absorbed by the second absorptive polarizer 270 or transmitted therethrough in the first state 226. Notably, the reflective polarizer 232 is configured to transmit light oriented in the first state 226, such that the light transmitted through the second absorptive polarizer 270 is transmitted therethrough, with none of the light 246 incident on the first side 220 of the body element 212 being reflected back by the reflective polarizer 232, because no light from the first side 220 is oriented in the range of orientation reflected by the reflective polarizer 232. In this manner, the present automotive visor 210 does not exhibit mirrored characteristics from the first side 220, which is visible to the driver when the visor 210 is in the stowed state and would be visible to those outside the vehicle when deployed. The effect of the absorptive polarizer 270 observed from the first side 220 is such that the body element 212 appears transparent, yet dimmed, when the TN-LC layer 230 is in the off state (as shown in FIG. 9) and appears opaque when the TN-LC layer 230 is in the on state. Notably, the TN-LC layer 230 is configured and functions the same as the TN-LC layer 30 discussed above with respect to FIGS. 4A-5. Additionally, the appearance of the body element 212 from the second side 222 is not affected by the presence of the second absorptive polarizer, such that the body element 212 remains transparent with the same polarizing effect as the body element 12 discussed above, when the TN-LC layer 230 is deactivated (and the electrochromic element 233 is in the transmissive state), and has the same mirrored appearance from the second side 222 when the TN-LC layer 230 is activated.

As further shown in FIG. 9, the body element 212 can also include a quarter-wave retarder 272 outside of the second absorptive polarizer 270 (such that the quarter-wave retarder 272 defines the second side 222 of the body element 212. In this manner, the light 254 exiting the second absorptive polarizer 270 in the first state 226 is changed to a depolarized state 248 when exiting the first side 220 of the body element 212 such that the above-described transparent, dimmed appearance is still observed by a user wearing polarized sunglasses. In this manner, if a passenger positions the visor 210 adjacent the side window 45 (FIG. 3), the driver can still see through the body element 212 while the TN-LC layer 230 is in the deactivated state. It will be appreciated that the body element 312 will exhibit generally similar viewing angle characteristics as that of body element 12, as discussed above with respect to FIG. 7, including with respect to the described viewing axes 60, 62, but that the particular degrees of visibility and the transition angles or limits discussed specifically above may vary due to the nature of the specific configuration of the individual elements of the body element 312 or the particular arrangement thereof. Additionally, as discussed above, the designation of the light 246 and 254 as being in first and second states 226 and 234 is made with respect to the order in which the states were originally introduced in this specification such that the designations are made to distinguish among orientation states with respect to the illustrations of the device in the drawings. Accordingly, it is to be understood that the designations are not made to limit the designated states to orientation in the horizontal or vertical directions, unless otherwise specified.

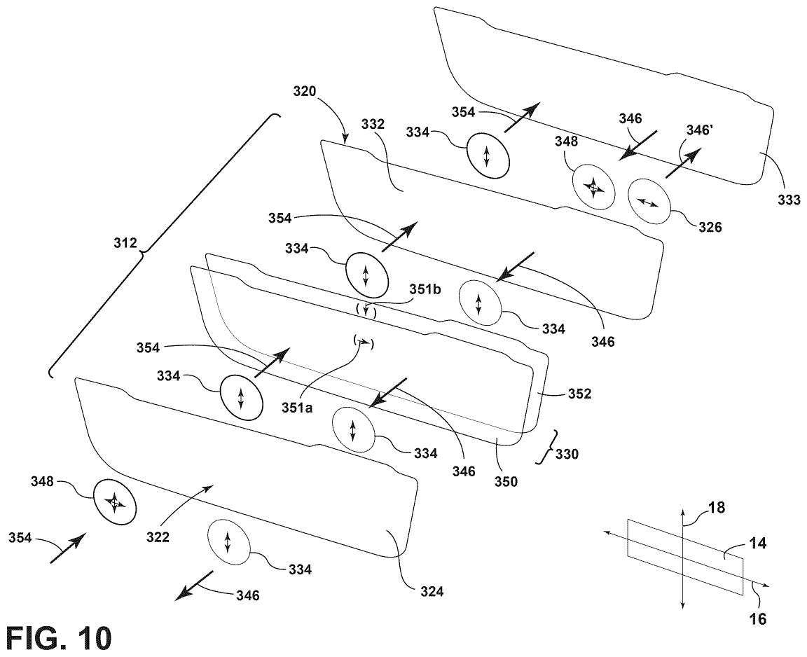

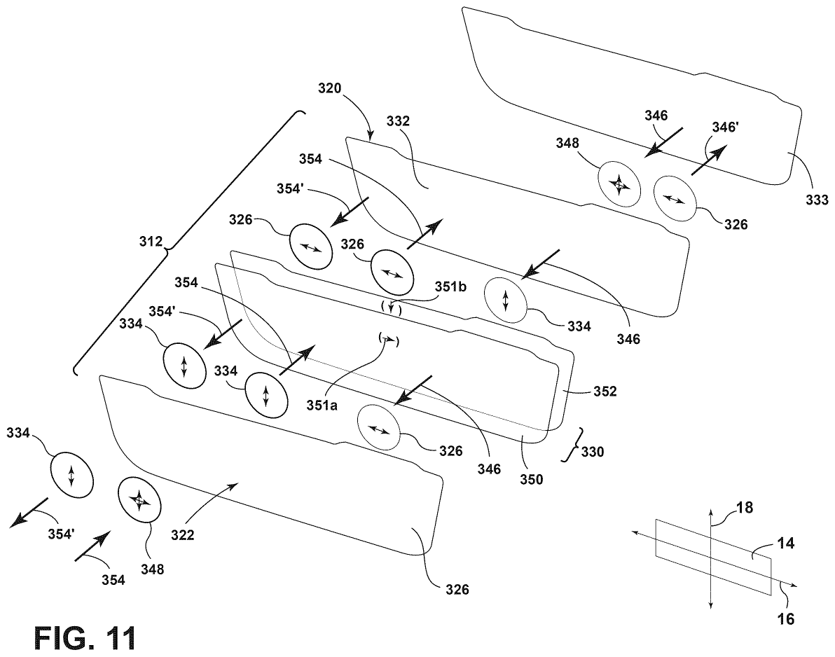

Turning to FIGS. 10 and 11, a still further variation of an automotive visor 310 is shown in which the body element 312 is configured to operate as a mirror, when viewed from the second side 322 when the TN-LC layer 330 is deactivated and to appear as generally transparent, as viewed from the second side 322, when the TN-LC layer 330 is activated, in a generally opposite arrangement from the variations of the automotive visor 10, 110, and 210 discussed above. In this respect, it is noted that other features not specifically discussed herein are similar to those discussed above, with such features being indicated in FIGS. 10 and 11 with similar reference numbers increased by 300. It is also noted that the particular variation of the body element 312 is configured for “vertical transmission” of light 346 when TN-LC layer 330 is in the deactivated state, by which the light 346 incident on the first side 320 and ultimately transmitted through the body element 312 is in the above-described second state 334, corresponding with the indicated second direction 18 (i.e., vertical in the depiction of FIG. 10). In this respect, it is noted that the light 354 transmitted through the body element 312 to the first side 320 is polarized in the vertical direction such that the light 354 is visible to a user wearing polarized sunglasses such that a quarter-wave retarder, as discussed above, is not needed.

As shown in FIG. 10, the TN-LC layer 330 is configured (including by way of the indicated first and second rubbing directions 351a, 351b) to transmit light 346 and 354 therethrough in the second state 334, without reorientation, when the TN-LC layer 330 is in the activated state (i.e., by application of power thereto). Correspondingly, both the absorptive polarizer 326 on the first side 322 and the reflective polarizer 332 are configured for transmission of light in the second state 334. Accordingly, when the TN-LC layer 330 is activated, both light 346 incident on the first side 320 and light 354 incident on the second side 322 are transmitted through the body element 312 in the second state 334. As shown in FIG. 11, when the TN-LC layer 330 is deactivated the light 346 and 354 is reoriented such that the light 346 incident on the first side 320 encounters the absorptive polarizer 324 on the second side 322 in the first state 326 such that it is absorbed thereby without exiting on the second side 322. Similarly, the reorientation of light 354 from the second state 334 to the first state 326 is such that it is reflected back toward the absorptive polarizer 324, ultimately back in the second state 334 such that it is transmitted, such that the body element 312 appears as a mirror. It will be appreciated that the body element 312 will exhibit generally similar viewing angle characteristics as that of body element 12, as discussed above with respect to FIG. 7, including with respect to the describe viewing axes 60, 62, but that the particular degrees of visibility and the transition angles or limits discussed specifically above may vary due to the nature of the specific configuration of the individual elements of the body element 312 or the particular arrangement thereof.

Notably, light 346 that is not in the second state 334 is reflected back from the first side 320 by the reflective polarizer 332 (indicated as in the first state 326), regardless of the activation state of the TN-LC layer 330. In this manner, a second absorptive polarizer can be positioned on the first side 320 of the reflective polarizer 332 in a similar manner to the absorptive polarizer 270 discussed above with respect to FIG. 9, to remove or reduce the mirrored appearance of the body element 312 from the first side 320. Additionally, a quarter-wave retarder can also be incorporated in a similar manner to the quarter-wave retarder 372 discussed above with respect to FIG. 9 for similar benefit. Again, as discussed above, the designation of the light 346 and 354 as being in first and second states 326 and 334 is made with respect to the order in which the states were originally introduced in this specification such that the designations are made to distinguish among orientation states with respect to the illustrations of the device in the drawings. Accordingly, it is to be understood that the designations are not made to limit the designated states to orientation in the horizontal or vertical directions, unless otherwise specified.

Returning to FIGS. 1 and 2, The automotive visor 10 further includes a frame structure 64 configured retaining the body element 12 and connecting the body element 12 with the mounting structure 42 for rotatable mounting of the body element 12 adjacent the windshield 44, as discussed above with respect to FIG. 3. In a further aspect, the automotive visor 10 can further include a controller 66 configured for changing the TN-LC cell layer 30 between the on state and the off state, including by selectively providing an electrical current to the same, including to one or more of the alignment layers 50 or 52. In one example, a user interface 68 can be positioned on the frame structure 64 to receive a user input corresponding with a desired mode of operation. The interface 68 can be connected with the controller 66 such that the input can be received by the controller 66.

As discussed above, in the automotive visor 10, and the additional variations thereof discussed herein, the liquid crystal cell layer 30 can be a vertical alignment liquid crystal cell layer such that when the body 12 is in the transmissive state, the light that enters the body element from the first side 20 in the first polarization state 26 exits the body on the second side 22 in the first polarization state 26. In such a variation, the absorptive polarizer layer 24 is configured to transmit light in the first polarization state 26 aligning with the first direction 16 therethrough while absorbing light not in the first polarization state, including light in the second polarization state 34 aligned with the second direction 18. Accordingly, when the VA-LC cell layer 30 is in the off state, light is transmitted therethrough and reoriented into the second polarization state and when the VA-LC cell layer 30 is in the on state, the polarization state of light transmitted therethrough is transmitted without being reoriented. Given such a configuration of the liquid crystal cell layer, the structure of the body element 12 can be adjusted according to the principles discussed herein to achieve the desired modes of operation consistent with the above disclosure.

The invention disclosed herein is further summarized in the following paragraphs and is further characterized by combinations of any and all of the various aspects described therein.

According to another aspect of the present disclosure, an automotive visor includes a selectively-transmissive body having an absorptive polarizer layer disposed on a second side of the body element, a twisted nematic liquid crystal cell layer juxtaposed with the absorptive polarizer layer and configurable between an off state and an on state, and a reflective polarizer layer disposed on a first side of the body element and juxtaposed with the absorptive polarizer layer. The body element is configurable, based on the state of the twisted nematic liquid crystal cell layer, in a transmissive state, wherein only light in a first polarization state enters the body element from the first side and exits the body on the second side in a second polarization state, and a mirror state such that only light incident on the reflective polarizer layer from the second side of the body element is visible from the second side of the body element. The automotive visor further includes an electrochromic element extending in the first and second directions and positioned adjacent the body element on the first side thereof, the electrochromic element being configurable at least in a transparent state and a darkened state.

In the automotive visor of ¶[0047], the selectively-transmissive body element can define a plane extending in first and second directions and can have a first side and a second side, the first polarization state aligning with the first direction, the second polarization state can align with the second direction, and the twisted nematic liquid crystal cell layer, reflective polarizer layer, and absorptive polarizer layer can extend along the first and second directions.

In the automotive visor of ¶[0048], the first direction and first polarization state can be oriented vertically, and the second direction and second polarization state can be oriented horizontally.

In the automotive visor of any one of ¶¶[0047] to [0049], the absorptive polarizer layer can be configured to transmit light in the first polarization state aligning with the first direction therethrough while absorbing light not in the first polarization state, including light in the second polarization state aligned with a second direction, when the twisted nematic liquid crystal cell layer is in the off state, a polarization state of light transmitted therethrough can be reoriented by 90 degrees, and when the twisted nematic liquid crystal cell layer is in the on state, light can be transmitted therethrough without reorientation of the polarization state.

In the automotive visor of ¶[0050], the body element can be configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element.

In the automotive visor of ¶[0051], the reflective polarizer layer can be configured to transmit light in the second polarization state, while reflecting light not in the second polarization state, including light in the first polarization state, and the configuration of the body element corresponds with the state of the twisted nematic liquid crystal cell layer such that the body element is in the transmissive state when the twisted nematic liquid crystal cell layer is in the off state and is in the mirror state when the twisted nematic liquid crystal cell layer is in the on state.

In the automotive visor of any of ¶¶[0050] to [0052], the reflective polarizer layer can be configured to transmit light in the first polarization state, while reflecting light not in the first polarization state, including light in the second polarization state, and the configuration of the body element corresponds with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

In the automotive visor of any of ¶¶[0047] to [0053], the absorptive polarizer layer disposed on the second side of the body element can be a first absorptive polarizer, and the automotive visor can further include a second absorptive polarizer layer disposed on the first side of the body element, extending along the first and second directions, and configured to transmit light in the second polarization state aligning with the second direction therethrough while absorbing light in the range outside of the second polarization state, including light in the first polarization state aligned with the first direction.

In the automotive visor of ¶[0054], the second direction can be generally horizontal, and the automotive visor can further include a quarter-wave retarder on the first side of the second absorptive polarizer layer and configured to reconfigure light transmitted therethrough such that at least some of the light is not in the second polarization state.

In the automotive visor of any of ¶¶[0047] to [0055], when the body element is in the transmissive state, the electrochromic element being switched between the transmissive state and the darkened state alternately allows and blocks light transmission to the body element.

In the automotive visor of any of ¶¶[0047] to [0056], the twisted nematic liquid crystal cell layer can include first and second alignment layers, each characterized by a respective rubbing direction, the rubbing direction of the first alignment layer can align with the first direction, and the rubbing direction of the second alignment layer can align with the second direction.

In the automotive visor of ¶¶[0057], light passing through the absorptive polarizer can be visible from the second side of the body element from outside a first viewing angle range, including when the body element is configured in the mirror state.

In the automotive visor of ¶[0058], light passing through the absorptive polarizer can be visible from the second side of the body element from outside a first viewing angle range, including when the body element is configured in the mirror state, only when a viewing angle outside the first viewing angle range is unaligned with polar axes extending in the first and second directions.

The automotive visor of any of ¶¶[0047] to [0059], can further include a mounting structure configured for rotatable mounting of the body element adjacent a windshield of a vehicle, and the body element can be coupled with the mounting structure.

The automotive visor of any one of ¶¶0047] to [0059], can further include a controller configured for changing the twisted nematic liquid crystal layer between the on state and the off state upon a corresponding input from a user.

According to yet another aspect, an automotive visor includes a selectively-transmissive body element having a first side and a second side. The body element has an absorptive polarizer layer disposed on the second side of the body element and configured to transmit light in a first polarization state aligning with a first direction therethrough while absorbing light not in the first polarization state, including light in a second polarization state aligned with a second direction, a twisted nematic liquid crystal cell layer juxtaposed with the absorptive polarizer layer and configurable between an off state, wherein a polarization state of light transmitted therethrough is reoriented by 90 degrees, and an on state, wherein light is transmitted therethrough without reorientation of the polarization state, and a reflective polarizer layer disposed on the first side of the body element, extending along the first and second directions, juxtaposed with the absorptive polarizer layer, and configured to transmit light in the first polarization state, while reflecting light not in the first polarization state, including light in the second polarization state. The automotive visor further includes an electrochromic element extending in the first and second directions and positioned adjacent the body element on the first side thereof. The electrochromic element is configurable at least in a transparent state and a darkened state. The body element is configurable in a transmissive state and a mirror state corresponding with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

In the automotive visor of ¶[0063], when the body element is in the transmissive state, the electrochromic element being switched between the transmissive state and the darkened state can alternately allow and block light transmission to the body element.

In the automotive visor of either ¶[0063] or ¶[0064], when the body element is in the transmissive state, light entering the body element from the first side can passe through to the second side of the body in the first polarization state, and, when the body element is in the mirror state, light entering the body element from the second side and passing through the absorptive polarizer layer in the first polarization state can be reflected back through the absorptive polarizer layer by the reflective polarizer layer in the first polarization state, such that only light incident on the reflective polarizer layer from the second side of the body element is visible from the second side of the body element.

According to yet another aspect, an automotive visor includes a selectively-transmissive body element defining a plane extending in first and second directions and having a first side and a second side. The body element includes an absorptive polarizer layer disposed on the second side of the body element, extending along the first and second directions, and configured to transmit light in a first polarization state aligning with the first direction therethrough while absorbing light not in the first polarization state, including light in a second polarization state aligned with a second direction, a twisted nematic liquid crystal cell layer extending along the first and second directions and juxtaposed with the absorptive polarizer layer, the twisted nematic liquid crystal cell layer being configurable between an off state, wherein a polarization state of light transmitted therethrough is reoriented by 90 degrees, and an on state, wherein light is transmitted therethrough without reorientation of the polarization state, and a reflective polarizer layer disposed on the first side of the body element, extending along the first and second directions, juxtaposed with the absorptive polarizer layer, and configured to transmit light in the first polarization state, while reflecting light not in the first polarization state, including light in the second polarization state. The automotive visor further includes an electrochromic element extending in the first and second directions and positioned adjacent the body element on the first side thereof, the electrochromic element being configurable at least in a transparent state and a darkened state. The body element is configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element. The configuration of the body element corresponds with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

In the automotive visor of ¶[0066], when the body element is in the transmissive state, the electrochromic element being switched between the transmissive state and the darkened state can alternately allow and block light transmission to the body element.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

1. An automotive visor, comprising:
a selectively-transmissive body including:
an absorptive polarizer layer disposed on a second side of the body element;
a liquid crystal cell layer juxtaposed with the absorptive polarizer layer and configurable between an off state and an on state; and
a reflective polarizer layer disposed on a first side of the body element and juxtaposed with the absorptive polarizer layer, the body element being configurable, based on the state of the liquid crystal cell layer, in a transmissive state, wherein only light in a first polarization state enters the body element from the first side and exits the body on the second side, and a mirror state such that only light incident on the reflective polarizer layer from the second side of the body element is visible from the second side of the body element; and
an electrochromic element extending in the first and second directions and positioned adjacent the body element on the first side thereof, the electrochromic element being configurable at least in a transparent state and a darkened state.

2. The automotive visor of claim 1, wherein:
the selectively-transmissive body element defines a plane extending in first and second directions and has a first side and a second side;
the first polarization state aligns with the first direction;
the second polarization state aligns with the second direction; and
the twisted nematic liquid crystal cell layer, reflective polarizer layer, and absorptive polarizer layer extend along the first and second directions.

3. The automotive visor of claim 1, wherein:
the liquid crystal cell layer is a twisted nematic liquid crystal cell layer; and
when the body is in the transmissive state, the light that enters the body element from the first side in the first polarization state exits the body on the second side in a second polarization state.

4. The automotive visor of claim 3, wherein:
the absorptive polarizer layer is configured to transmit light in the first polarization state aligning with the first direction therethrough while absorbing light not in the first polarization state, including light in the second polarization state aligned with a second direction;
when the twisted nematic liquid crystal cell layer is in the off state, a polarization state of light transmitted therethrough is reoriented by 90 degrees; and
when the twisted nematic liquid crystal cell layer is in the on state, light is transmitted therethrough without reorientation of the polarization state.

5. The automotive visor of claim 4, wherein the body element is configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element.

6. The automotive visor of claim 5, wherein:
the reflective polarizer layer is configured to transmit light in the second polarization state, while reflecting light not in the second polarization state, including light in the first polarization state; and
the configuration of the body element corresponds with the state of the twisted nematic liquid crystal cell layer such that the body element is in the transmissive state when the twisted nematic liquid crystal cell layer is in the off state and is in the mirror state when the twisted nematic liquid crystal cell layer is in the on state.

7. The automotive visor of claim 4, wherein:
the reflective polarizer layer is configured to transmit light in the first polarization state, while reflecting light not in the first polarization state, including light in the second polarization state; and
the configuration of the body element corresponds with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

8. The automotive visor of claim 3, wherein the absorptive polarizer layer disposed on the second side of the body element is a first absorptive polarizer, the automotive visor further including:
a second absorptive polarizer layer disposed on the first side of the body element, extending along the first and second directions, and configured to transmit light in the second polarization state aligning with the second direction therethrough while absorbing light in the range outside of the second polarization state, including light in the first polarization state aligned with the first direction.

9. The automotive visor of claim 8, wherein the second direction is generally horizontal, the automotive visor further including:
a quarter-wave retarder on the first side of the second absorptive polarizer layer and configured to reconfigure light transmitted therethrough such that at least some of the light is not in the second polarization state.

10. The automotive visor of claim 3, wherein:
the twisted nematic liquid crystal cell layer includes first and second alignment layers, each characterized by a respective rubbing direction; and
the rubbing direction of the first alignment layer aligns with the first direction; and
the rubbing direction of the second alignment layer aligns with the second direction.

11. The automotive visor of claim 10, wherein light passing through the absorptive polarizer is visible from the second side of the body element from outside a first viewing angle range, including when the body element is configured in the mirror state.

12. The automotive visor of claim 11, wherein light passing through the absorptive polarizer is visible from the second side of the body element from outside a first viewing angle range, including when the body element is configured in the mirror state, only when a viewing angle outside the first viewing angle range is unaligned with polar axes extending in the first and second directions.

13. The automotive visor of claim 1, wherein, when the body element is in the transmissive state, the electrochromic element being switched between the transmissive state and the darkened state alternately allows and blocks light transmission to the body element.

14. The automotive visor of any of the preceding claims, further including a mounting structure configured for rotatable mounting of the body element adjacent a windshield of a vehicle, wherein:
the body element is coupled with the mounting structure.

15. The automotive visor of claim 1, further including a controller configured for changing the twisted nematic liquid crystal layer between the on state and the off state upon a corresponding input from a user.

16. The automotive visor of claim 1, wherein:
the liquid crystal cell layer is a vertical alignment liquid crystal cell layer; and
when the body is in the transmissive state, the light that enters the body element from the first side in the first polarization state exits the body on the second side in a second polarization state.

17. The automotive visor of claim 16, wherein:
the absorptive polarizer layer is configured to transmit light in the first polarization state aligning with the first direction therethrough while absorbing light not in the first polarization state, including light in a second polarization state aligned with a second direction;
when the vertical alignment liquid crystal cell layer is in the on state, a polarization state of light transmitted therethrough is reoriented by 90 degrees; and
when the vertical alignment liquid crystal cell layer is in the off state, light is transmitted therethrough without reorientation of the polarization state.

18. An automotive visor, comprising:
a selectively-transmissive body element having a first side and a second side, the body element comprising:
an absorptive polarizer layer disposed on the second side of the body element and configured to transmit light in a first polarization state aligning with a first direction therethrough while absorbing light not in the first polarization state, including light in a second polarization state aligned with a second direction;
a twisted nematic liquid crystal cell layer juxtaposed with the absorptive polarizer layer and configurable between an off state, wherein a polarization state of light transmitted therethrough is reoriented by 90 degrees, and an on state, wherein light is transmitted therethrough without reorientation of the polarization state; and
a reflective polarizer layer disposed on the first side of the body element, extending along the first and second directions, juxtaposed with the absorptive polarizer layer, and configured to transmit light in the first polarization state, while reflecting light not in the first polarization state, including light in the second polarization state; and
an electrochromic element extending in the first and second directions and positioned adjacent the body element on the first side thereof, the electrochromic element being configurable at least in a transparent state and a darkened state;
wherein the body element is configurable in a transmissive state and a mirror state corresponding with the state of the twisted nematic liquid crystal cell layer such that the body element is in the transmissive state when the twisted nematic liquid crystal cell layer is in the on state and is in the mirror state when the twisted nematic liquid crystal cell layer is in the off state.

19. The automotive visor of claim 16, wherein:
when the body element is in the transmissive state, light entering the body element from the first side passes through to the second side of the body in a second polarization state;
when the body element is in the mirror state, light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element; and
when the body element is in the transmissive state, the electrochromic element being switched between the transmissive state and the darkened state alternately allows and blocks light transmission to the body element.

20. An automotive visor, comprising:
a selectively-transmissive body element defining a plane extending in first and second directions and having a first side and a second side, the body element comprising:
an absorptive polarizer layer disposed on the second side of the body element, extending along the first and second directions, and configured to transmit light in a first polarization state aligning with the first direction therethrough while absorbing light not in the first polarization state, including light in a second polarization state aligned with a second direction;
a twisted nematic liquid crystal cell layer extending along the first and second directions and juxtaposed with the absorptive polarizer layer, the twisted nematic liquid crystal cell layer being configurable between an off state, wherein a polarization state of light transmitted therethrough is reoriented by 90 degrees, and an on state, wherein light is transmitted therethrough without reorientation of the polarization state; and
a reflective polarizer layer disposed on the first side of the body element, extending along the first and second directions, juxtaposed with the absorptive polarizer layer, and configured to transmit light in the first polarization state, while reflecting light not in the first polarization state, including light in the second polarization state; and
an electrochromic element extending in the first and second directions and positioned adjacent the body element on the first side thereof, the electrochromic element being configurable at least in a transparent state and a darkened state;
wherein:
the body element is configurable in a transmissive state, wherein light entering the body element from the first side passes through to the second side of the body in the first polarization state, and a mirror state, wherein light entering the body element from the second side and passing through the absorptive polarizer layer in the first polarization state is reflected back through the absorptive polarizer layer by the reflective polarizer layer in the first polarization state, such that only light incident on the reflective polarizer layer from the second side of the body element is visible from the second side of the body element, the configuration of the body element corresponding with the state of the twisted nematic liquid crystal cell layer such that the body element is in the transmissive state when the twisted nematic liquid crystal cell layer is in the on state and is in the mirror state when the twisted nematic liquid crystal cell layer is in the off state.
